(19) United States
(12) Patent Application Publication
(10) Pub. No.: US 2026/0064764 A1
(43) Pub. Date: Mar. 5, 2026

(54) PROVIDING RECOMMENDED IMAGE DATA

(71) Applicant: Walmart Apollo, LLC, Bentonville, AR (US)

(72) Inventors: Jae Young Kim, Sunnyvale, CA (US); Zigeng Wang, Santa Clara, CA (US); Wei Shen, Pleasanton, CA (US)

(21) Appl. No.: 19/292,526

(22) Filed: Aug. 6, 2025

Related U.S. Application Data
(60) Provisional application No. 63/689,117, filed on Aug. 30, 2024.

(51) Int. Cl. G06F 16/535; G06N 20/00

(52) U.S. Cl. CPC G06F 16/535; G06N 20/00

(57) ABSTRACT

Systems and methods for retrieving and providing images are disclosed. An example system receives, from a user device, a request for an image. The system determines, using a machine-learning model, search embeddings based on the request; filters image data based on the request to identify a filtered set of the image data; and obtains a subset of the image embeddings corresponding to the filtered set of the image data. The system further determines based on a comparison of the search embeddings and the subset of the image embeddings, recommended image data, and causes presentation of the recommended image data at the user device. In response to selection of the recommended image data, the system provides the recommended image data to the user device.

### CROSS REFERENCE TO RELATED APPLICATION

This application claims benefit to U.S. Patent Application Ser. No. 63/689,117, entitled “PROVIDING RECOMMENDED IMAGE DATA,” filed on Aug. 30, 2024, the disclosure of which is incorporated herein by reference in its entirety.

### TECHNICAL FIELD

This application relates generally to an image retrieval system, and more particularly, to a multimodal image search system for identifying, retrieving, and presenting recommended images based on text-based requests, image-based requests, and/or campaign requests.

### BACKGROUND

Users may manually curate images for campaigns. The selection of appropriate images factors into capturing the attention of potential customers and driving engagement with a particular brand and/or product. However, manually curating images that not only align with the campaign's objectives, but also resonate with the target audience can be a labor intensive and highly subjective process.

As such there is a need for more efficient and reliable system for image selection that streamline the image selection process and enhance the overall effectiveness of campaigns.

### BRIEF DESCRIPTION OF THE DRAWINGS

Various examples will be described by the following detailed description, which is to be considered together with the accompanying drawings wherein like numbers refer to like parts and further wherein:

FIG. 1 illustrates a network environment that retrieves image data, in accordance with some embodiments;

FIG. 2 illustrates a block diagram of a computing device, in accordance with some embodiments;

FIGS. 3A and 3B illustrates an example user interface for interacting with a multimodal image search system for retrieving images, in accordance with some embodiments;

FIG. 4 illustrates an example multimodal image search system, in accordance with some embodiments;

FIGS. 5A and 5B illustrate training and use of a circular filter, in accordance with some embodiments;

FIG. 6 illustrates a text filter, in accordance with some embodiments;

FIG. 7 illustrates a duplication filter, in accordance with some embodiments; and

FIG. 8 is a flowchart illustrating a method for retrieving one or more images, in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for retrieving image data, and more specifically, retrieving product or item related image data, for a campaign. In various embodiments, the methods and systems disclose a multimodal image retrieval system. In some embodiments, the multimodal image retrieval systems utilize circular, text-heavy, and/or deduplication filters that significantly improve image retrieval efficiency and accuracy. The disclosed filters effectively and accurately filter circular and text-heavy images, ensuring more relevant and visually appealing search results and/or retrieved images. Additionally, the duplication detection filters significantly reduce computational overhead and improve the overall efficiency when handling large (image) datasets (e.g., datasets including more than a thousand images or data points). In some embodiments, the multimodal image retrieval systems leverage advanced multimodal embedding models, which allow for precise image retrieval using text inputs and/or image inputs. In some embodiments, the multimodal image retrieval systems are fine-tuned using incremental task scaling fine-tuning, which progressively trains model of the multimodal image retrieval systems with increasingly difficult tasks and, thereby, improving the performance of the models and/or multimodal image retrieval systems.

The methods and systems disclosed herein provide timesaving tools with improved accuracy. To this point, the methods and systems disclose models that automate the process of searching and selecting relevant images for marketing campaigns, reducing manual effort, and increasing efficiency, as well as models for retrieving images with higher relevancy and context, ensuring better alignment with user objectives. The methods and systems disclosed herein are customizable providing advanced filtering techniques like circular image, text-heavy image, and deduplication filters that can tailor results that meet user needs and objectives. The methods and systems disclosed herein also improve user and/or customer experience by retrieving visually captivating and contextually pertinent images, enhancing overall user and/or customer experience. The methods and systems disclosed herein include cross-modality understanding such that the disclosed models can capture relationships between and within text and images, offering a more comprehensive understanding of the content. Additionally, the methods and systems disclosed herein allow the models to learn from new images and texts, making them versatile and scalable solutions for ever-evolving platforms (e.g., ecommerce platforms). The artificially intelligence assisted search and image selection automation provided by the disclosed methods and systems can revolutionize the method of designing and executing marketing campaigns.

The systems and methods disclosed herein provide comprehensive multi-modal image retrieval systems that automatically search and return relevant images based on text-based, visual-based (e.g., image) queries, and/or campaign queries. The systems and methods disclosed herein leverage artificial intelligence to streamline the image selection process while reducing the computational demands of the multi-modal image retrieval systems and reducing overall latency. For example, the systems and methods disclosed herein can use one or more filters and/or pre-indexed data to reduce the total number of images processed by the multi-modal image retrieval systems, which reduces the overall latency and computational demands. In some embodiments, the multi-modal image retrieval systems are trained on dataset pairs, which allow for the progressive training of models with increasingly difficult tasks, thereby improving performance of the models. For example, models can be trained with product image and text pairs, which allows the models to understand the relationship between and within text and images, and retrieve the most suitable images from an extensive image database.

The systems and methods disclosed herein are tailored to search for images that satisfy specific requirements of various campaigns and/or user requests. The systems and methods disclosed herein improve image relevancy and understand background context, which improves overall user experience. The systems and methods disclosed herein incorporate advanced filtering techniques, such as circular image, text-heavy image, and deduplication filters. The filters ensure that the retrieved images are not only relevant but also visually appealing and unique, minimizing redundancy and enhancing the overall impact of the campaign. Additionally, the systems and methods disclosed herein provide practical applications for various e-commerce scenarios, with a focus on image selection improvement for push notifications and artificial intelligence assisted searches.

In various embodiments, a system for retrieving images is disclosed. The system includes a processor and a non-transitory memory storing instructions. The instructions, when executed, cause the processor to receive, from a user device, a request for an image. The processor further determines, using a machine-learning model, search embeddings based on the request; filter the image data based on the request to identify a filtered set of the image data; and obtain a subset of the image embeddings corresponding to the filtered set of the image data. The processor further determines based on a comparison of the search embeddings and the subset of the image embeddings, recommended image data, and cause presentation of the recommended image data at the user device. In response to selection of the recommended image data, the processor further provides the recommended image data to the user device.

In various embodiments, a computer-implemented method for retrieving image data is disclosed. The computer-implemented method includes steps of receiving, from a user device, a request for an image. The computer-implemented method further includes steps of determining, using a machine-learning model, search embeddings based on the request; filtering the image data based on the request to identify a filtered set of the image data; and obtaining a subset of the image embeddings corresponding to the filtered set of the image data. The computer-implemented method also includes steps of determining based on a comparison of the search embeddings and the subset of the image embeddings, recommended image data, and causing presentation of the recommended image data at the user device. The computer-implemented method includes steps of in response to selection of the recommended image data, providing the recommended image data to the user device.

In various embodiments, a non-transitory computer readable medium having instructions stored thereon is disclosed. The instructions, when executed by at least one processor, cause at least one device to perform operations including receiving, from a user device, a request for an image. The instructions, when executed by at least one processor, further cause the at least one device to perform operations including determining, using a machine-learning model, search embeddings based on the request; filtering the image data based on the request to identify a filtered set of the image data; and obtaining a subset of the image embeddings corresponding to the filtered set of the image data. The instructions, when executed by at least one processor, also cause the at least one device to perform operations including determining based on a comparison of the search embeddings and the subset of the image embeddings, recommended image data, and causing presentation of the recommended image data at the user device. The instructions, when executed by at least one processor, cause the at least one device to perform operations including in response to selection of the recommended image data, providing the recommended image data to the user device.

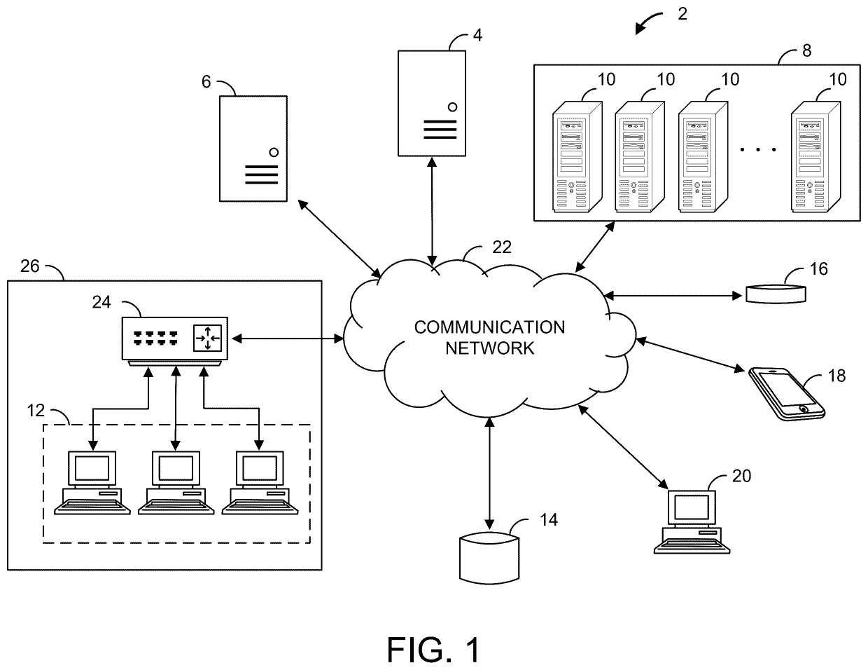

FIG. 1 illustrates a network environment 2 that retrieves image data, in accordance with some embodiments. The network environment 2 includes a plurality of devices or systems to communicate over one or more network channels, illustrated as a communication network 22. For example, in various embodiments, the network environment 2 may include, but is not limited to, a multimodal image retrieval computing device 4, a web server 6, a cloud-based engine 8 including one or more processing devices 10, a database 14, and/or one or more user computing devices 16, 18, 20 operatively coupled over the communication network 22. The multimodal image retrieval computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the multimodal image retrieval computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the multimodal image retrieval computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the multimodal image retrieval computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the multimodal image retrieval computing device 4, for example. The workstation(s) 12 may communicate with the multimodal image retrieval computing device 4 over the communication network 22. The workstation(s) 12 may send data to, and receive data from, the multimodal image retrieval computing device 4. For example, the workstation(s) 12 may transmit data related to tracked operations performed at the physical location 26 to the multimodal image retrieval computing device 4.

Although FIG. 1 illustrates three user computing devices 16, 18, 20, the network environment 2 may include any number of user computing devices 16, 18, 20. Similarly, the network environment 2 may include any number of the multimodal image retrieval computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the multimodal image retrieval computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser or programs operating on the user computing devices, perform various operations such as filtering image data, determining recommended images based on user requests, presenting the recommended images, etc. The website may capture user requests including text-based requests, image-based request, campaign requests; filter selection and/or customization; and transmit the request to the multimodal image retrieval computing device 4 over the communication network 22. The website may also allow the user to interact with one or more of interface elements to perform specific operations, such as selecting a recommended image.

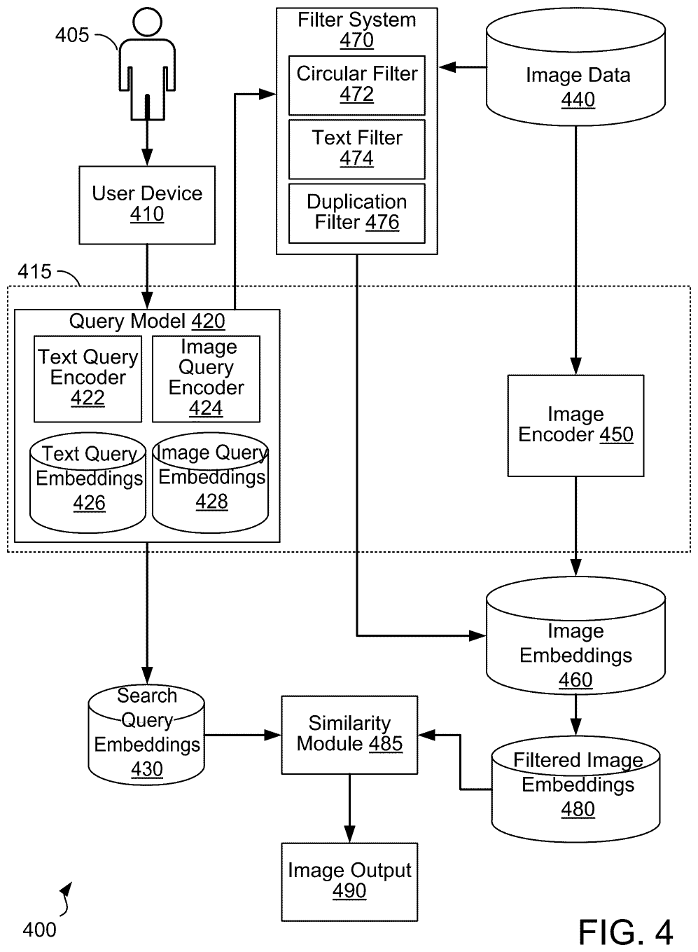

In some embodiments, the multimodal image retrieval computing device 4 may execute one or more models, processes, or algorithms, such as a multimodal image search model 415 and a filter system 470 (FIG. 4), to receive and/or transform the request, filter image data based on the received and/or transformed request, identify image embeddings based on the filtered image data, determine recommended images based on the identified image embeddings and the transformed request, present the recommended images to a user, and/or perform other operations described below. The multimodal image retrieval computing device 4 may transmit recommended images and related data to the web server 6 over the communication network 22, and the web server 6 may provide the recommended images for generation of one or more campaigns based on the request and/or perform one or more operations based on the recommend images.

The multimodal image retrieval computing device 4 is further operable to communicate with the database 14 over the communication network 22. For example, the multimodal image retrieval computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the multimodal image retrieval computing device 4, in some embodiments, the database 14 may be a local storage device, such as a hard drive, a non-volatile memory, or a USB stick. The multimodal image retrieval computing device 4 may store interaction data received from the web server 6 in the database 14. The multimodal image retrieval computing device 4 may also receive from the web server 6 user session data identifying events associated with browsing sessions, and may store the user session data in the database 14.

In some embodiments, the multimodal image retrieval computing device 4 assigns one or more models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the multimodal image retrieval computing device 4 may generate one or more image recommendations and/or image embeddings to be added to, distributed to, and/or stored in the database and/or communicatively coupled devices via the communication network 22.

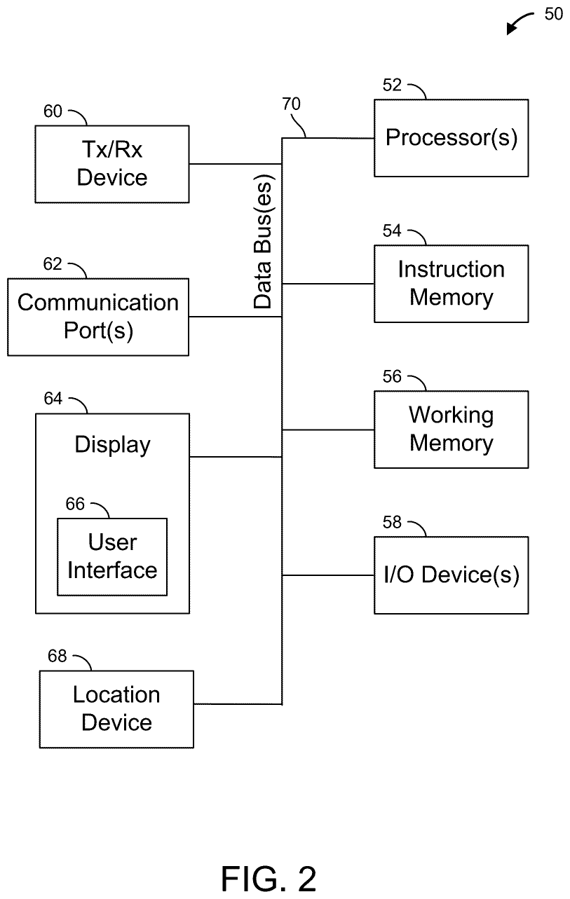

FIG. 2 illustrates a block diagram of a computing device 50, in accordance with some embodiments. In some embodiments, each of the multimodal image retrieval computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input-output devices 58, a transceiver 60, one or more communication port(s) 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may perform a certain function or operation by executing code, stored on the instruction memory 54, embodying the function or operation. For example, the one or more processors 52 may execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit operating as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for determining recommended images, retrieving the recommended images, and/or presenting the recommended images, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 allows communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with extracted attributes. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device to receive position data identifying a latitude and longitude from one or more satellites of a GPS constellation. As another example, in some embodiments, the location device 68 is a cellular device to receive location data from one or more localized cellular towers. Based on the position data, the computing device 50 may determine a local geographical area (e.g., town, city, state, etc.) of its position.

In some embodiments, the computing device 50 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation discussed herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

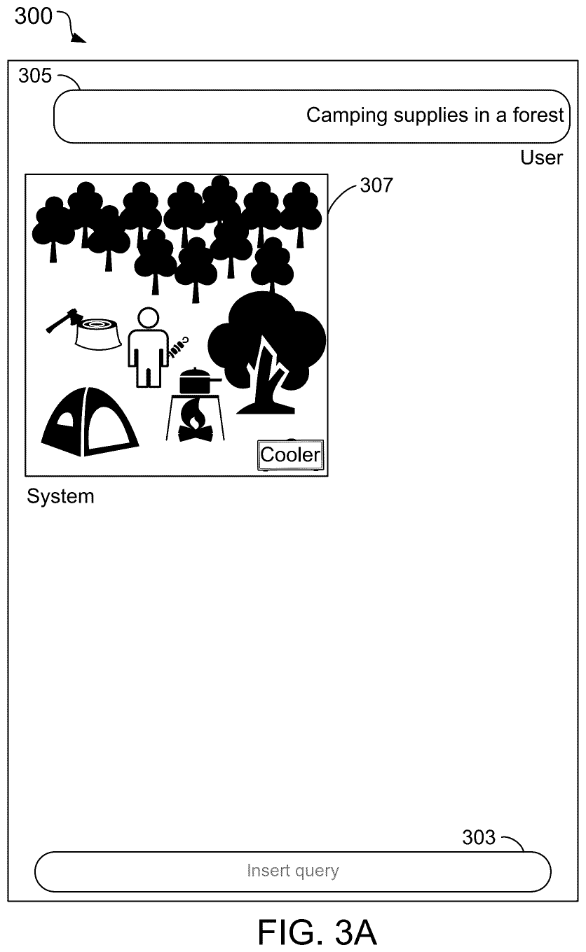

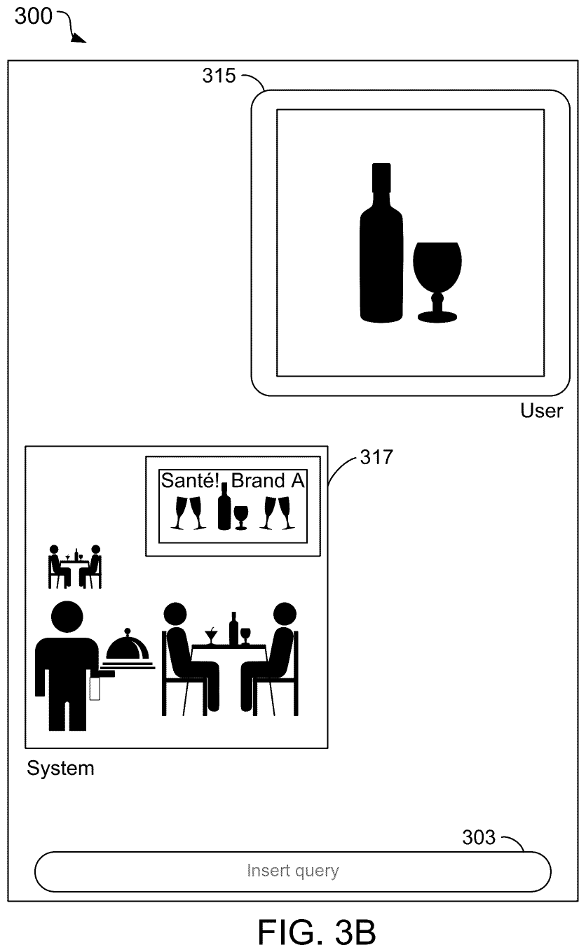

FIGS. 3A and 3B illustrate example user interfaces for interacting with a multimodal image search system for retrieving images, in accordance with some embodiments. An image retrieval user interface (UI) 300 can be presented at a user device (e.g., one or more user computing devices 16, 18, 20) and/or any other device described above in reference to FIG. 1. The image retrieval UI 300 includes one or more UI elements and/or UI input fields. In some embodiments, the UI input fields can include text input fields, image data input fields, document input fields, and/or other input fields. For example, in FIG. 3A, the image retrieval UI 300, at a first point in time, includes a user message UI element 305 and an input field 303. The user message UI element 305 corresponds to a request provided by a user via the input field 303. The user message UI element 305 includes a text-based request that is provided to a multimodal image search system 400 (FIG. 4). The multimodal image search system 400 processes the user message UI element 305 to determine one or more search parameters, filter parameters, image parameters, item and/or product parameters, campaign parameters, and/or other parameters. For example, the user message UI element 305 includes the request “Camping supplies in a forest,” and the multimodal image search system 400 can extract one or more search-related parameters based on the user message UI element 305 (e.g., types of camping supplies, camp sites, retail stores including camping supplies, etc.).

The multimodal image search system 400 further determines and retrieves images corresponding to the request. In particular, stored images are compared against the request to identify one or more images satisfying similarity criteria. Images satisfying the similarity criteria are retrieved and provided to the user. For example, as further shown in FIG. 3A, the image retrieval UI 300 includes an image 307 that is retrieved and provided by the multimodal image search system 400 in response to the user message UI element 305. In particular, the retrieved image 307 includes a person camping in the forest with their supplies, which is consistent with the “Camping supplies in a forest” request included in the user message UI element 305. Additional information on the similarity criteria and the multimodal image search system 400 is provided below in reference to FIG. 4.

Turning for FIG. 3B, the image retrieval UI 300, at a second point in time, includes another user message UI element 315 and the input field 303. The other user message UI element 315 corresponds to another request provided by the user via the input field 303. The other user message UI element 315 includes an image-based request and is provided to the multimodal image search system 400 for processing. The multimodal image search system 400 processes the other user message UI element 315 to determine one or more search-related parameters as described above. For example, the other user message UI element 315 includes a wine bottle, and the multimodal image search system 400 can extract one or more search-related parameters based on the other user message UI element 315 (e.g., a brand of the wine, a type of wine, a price associated with the wine, a restaurant providing the wine, a retail store including the wine, etc.)

The multimodal image search system 400 further determines and retrieves images corresponding to an additional request. For example, as further shown in FIG. 3B, the image retrieval UI 300 includes a second image 317 that is retrieved and provided by the multimodal image search system 400 in response to an additional user message UI element 315. In particular, the retrieved image 307 includes a restaurant sponsored, owned, and/or partnered by Brand A wine.

In some embodiments, each retrieved image is presented with a respective score (e.g., a matching score showing how closely the recommended image aligns with the user request). The one or more retrieved images can be reviewed and/or approved by the user. In some embodiments, the user can reject and/or provide an additional request to modify the retrieved images and/or receive new and/or additional images. In some embodiments, approved images are provided to a campaign building module and/or a system for generating campaigns using the approved images. The above-example UI elements are non-limiting and additional information can be presented to the user.

FIG. 4 illustrates an example multimodal image search system, in accordance with some embodiments. The multimodal image search system 400 is able to search and retrieve one or more images based on user requests of multiple types, such as text, images, or both. The multimodal image search system 400 includes and/or is in communication with a multimodal image search model 415, a filter system 470, a similarity module 485, and a database and/or memory storing image data 440 and image embeddings 460. Embeddings include, but are not limited to, vector representations of an element (e.g., a word) that is representative of a meaning of the word such that similar elements are closer in the vector space. As discussed below, the multimodal image search model 415 may include a query module 420 for generating one or more search query embeddings 430 and may include an image encoder 450 for generating the image embeddings 460. The multimodal image search system 400 can include and/or is in communication with a user device 410 (e.g., one or more user computing devices 16, 18, 20 and/or any other device described above in reference to FIG. 1). The multimodal image search system 400 and/or one or more components thereof can be included in a multimodal image retrieval computing device 4 (FIG. 1).

In some embodiments, the user device 410 may include one or more modules of the multimodal image search system 400. For example, the user device 410 can include the multimodal image search model 415, the filter system 470, the similarity module 485, and/or other modules shown and described in reference to FIG. 4. A user 405 can use the user device 410 to interface with the multimodal image search system 400. For example, the multimodal image search system 400 can initiate an application at the user device 410 and cause presentation of a UI, such as the image retrieval UI 300, at the user device 410. Alternatively, or in addition, the user device 410 can access the image retrieval UI 300 via a browser or other web application. In some embodiments, the multimodal image search system 400 allows the user 405 to initiate or build a campaign using one or more retrieved images (e.g., image output 490). Alternatively, or in addition, in some embodiments, the user 405 may initiate or build the campaign using the one or more images retrieved images via a browser or other web application.

The user 405 provides, via the user device 410, a request to retrieve one or more images. The request may be a text-based request and/or an image-based request. Alternatively, or in addition, in some embodiment, the multimodal image search system 400 is communicatively coupled with a campaign building system and/or campaign pushing system that provides a campaign request (e.g., analogous to a text-based request and/or an image-based request). For example, a campaign request may be a slogan, a story or imagery intended to be conveyed by the campaign, a campaign title, a campaign (product) category, a product, a campaign banner, and/or other campaign related information. The request is provided to the multimodal image search system 400 via the user device 410, campaign building system, and/or campaign pushing system. In particular, the request is provided to the multimodal image search model 415 and/or the filter system 470. For example, an example request, such as the user message UI element 305 and/or the other user message UI element 315 (FIGS. 3A and 3B), is input by the user 405 at an image retrieval UI 300 presented at the user device 410 and provided to the multimodal image search model 415 and/or the filter system 470.

The multimodal image search model 415 receives the request and provides the request to the query module 420. The query module 420 may include a text query encoder 422 for generating one or more text query embeddings 426 and may include an image query encoder 424 for generating one or more image query embeddings 428. The query module 420 provides text-based requests to the text query encoder 422, which may extract one or more search-related parameters, for example using one or more trained search models, based on the text-based requests and generate the text query embeddings 426, for example, using one or more known methods such as word2vec. Similarly, the query module 420 provides image-based requests to the image query encoder 424, which extracts one or more search-related parameters based on the image-based requests and generate the image query embeddings 428. In some embodiments, the text query embeddings 426 and/or the image query embeddings 428 are stored in the search query embeddings 430. Alternatively, or in addition, in some embodiments, the text query embeddings 426 and/or the image query embeddings 428 are consolidated and stored in the search query embeddings 430.

Additionally, the multimodal image search model 415 receives the image data 440 and provides the image data 440 to the image encoder 450. The image encoder 450 generates the image embeddings 460 based on the images in the image data 440. In some embodiments, the image embeddings 460 are pre-populated. More specifically, the image encoder 450 generates the image embeddings 460 before a request is provided. In some embodiments, the image embeddings 460 are periodically updated or re-calculated. The image embeddings 460 are (pre-) indexed with respective images in the image data 440. Because the image embeddings 460 are precalculated and (pre) indexed, images may be easily identified and retrieved, which improves image retrieval performance and allows the multimodal image search system 400 to be scalable.

The multimodal image search model 415 is a machine-learning model utilizing cross-modality embedding models to calculate the embeddings. The cross-modality embedding models may be configured to receive two or more modalities (e.g., text and images) and map features extracted from each of the modalities into embedding (e.g. vector) space. The multimodal image search model 415 may be fine-tuned using incremental task scaling fine-tuning. Incremental task scaling fine-tuning includes providing a first set of tasks to train the multimodal image search model 415 and providing a second set of tasks to train the multimodal image search model 415 after completion of the first set of tasks. The first set of tasks has a first complexity, and the second set of tasks has a second complexity greater than the first complexity. The first set of tasks includes a first set of data, the first set of data including first training image data and training text; and the second set of tasks includes a second set of data, the second set of data including second training image data and training categories. For example, the multimodal image search model 415 may be initially trained using an image and text pair such that the multimodal image search model 415 is first fine-tuned on cross entropy loss of image embeddings and text embeddings, and then the multimodal image search model 415 may be trained using a (product) image and (product) category pair such that the multimodal image search model 415 is fine-tuned on cross entropy loss of image embeddings and category embeddings (which may be more abstract and/or have limited information to create relationships).

The filter system 470 receives the request and/or respective query embeddings (e.g., from the multimodal image search model 415 and/or the user device 410). The filter system 470 filters the image data 440 before the image retrieval process is executed. In particular, the filter system 470 may identify a subset of images of the image data 440 to be used in the image retrieval process. In some embodiments, the image data 440 includes a large number of images or data points (e.g., more than 1000 images, more than 10,000 images, more than 100,000 images, etc.) and, to improve efficiency and latency, the filter system 470 excludes images that are not suitable based on the needs and/or requirements of the user 405 and/or other image requirements (e.g., campaign requirements, such as image size, image shape, image resolution, image content, etc.).

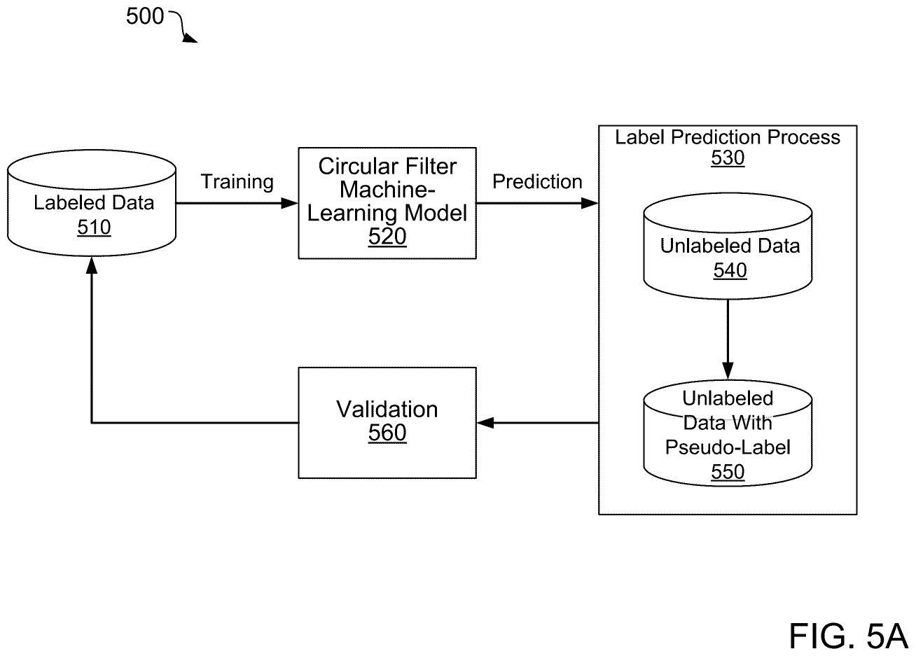

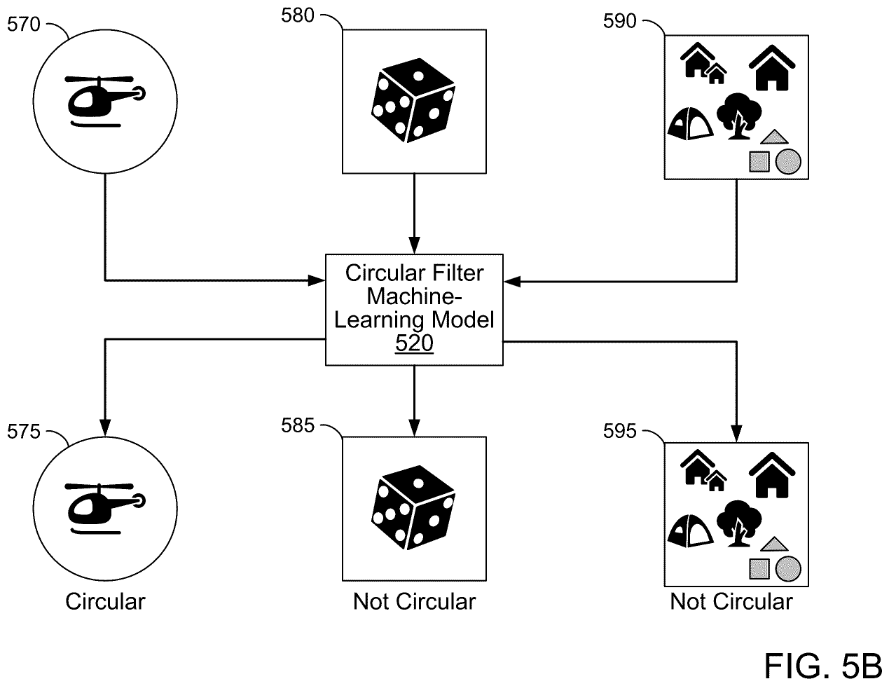

The filtered images are associated with respective image embeddings that are generated from the images (e.g., the filtered images have one or more data associations with respect to the respective image embeddings) in the image embeddings 460 to identify filtered image embeddings 480. The filter system 470 improves scalability by identifying images for the image retrieval process instead of processing the entire image data 440. The filter system 470 includes a circular filter 472, a text filter 474, and a duplication filter 476. The circular filter 472 identifies and excludes circular images (i.e., circular in shape) from the subset of images used in the image retrieval process. The text filter 474 identifies and excludes text-heavy images (e.g., a substantial portion of text (e.g., more than 50% text)) from the subset of images used in the image retrieval process. The duplication filter 476 identifies and duplicates images from the subset of images used in the image retrieval process. Each of the filters is discussed in detail below in reference to FIGS. 5A-7.

One or more filters of the filter system 470 may be optional. In some embodiments, one or more filters of the filter system 470 are selected by the user 405. For example, the request provided by the user 405 may indicate whether circular images should be filtered. In some embodiments, selection of the one or more filters is provided via a UI (e.g., image retrieval UI 300). For example, one or more radio button UI elements, check box UI elements, and/or other UI elements allow the user 405 to apply one or more filters. Alternatively, or in addition, in some embodiments, the user 405 may include the filter selection in a text-based and/or image-based request. The above-defined filters are non-limiting; additional filters not shown may be used.

The similarity module 485 compares the search query embeddings 430 and the filtered image embeddings 480 to identify relevant images for retrieval. In particular, the similarity module 485 is used to retrieve similar images from image data 440 by calculating cosine similarity distance between filtered image embeddings 480 and the search query embeddings 430. In some embodiments, similar images are images associated with a calculated cosine similarity distance equal to or greater than a predetermined value. Alternatively, or in addition, in some embodiments, the images are ranked and presented in a ranked order (e.g., based on respective calculated cosine similarity distance and/or match scores). The above examples are non-limiting and additional similarity criteria may be used to identify similar images, such as keyword similarity, metadata similarity, image classification, etc. In some embodiments, different models may be used for determining similarity. For example, an approximate nearest neighbor (ANN) model may be used for determining similarity.

The similar images are provided as image output 490. In particular, relevant images are retrieved from the image data 440 and provided to the user device 410 (and/or other communicatively coupled device). The image output 490 is presented to the user 405 via the user device 410 (and/or other communicatively coupled device). Each of the similar images is presented for selection by the user 405. Alternatively, in some embodiments, an image with the highest score is automatically selected for a campaign.

FIGS. 5A and 5B illustrate training and use of a circular filter, in accordance with some embodiments. FIG. 5A shows a circular filter model training process 500. The circular filter model training process 500 includes labeled data 510, a circular filter machine-learning model 520, a label prediction process 530, and a validation operation 560. The label prediction process 530 includes assigning unlabeled data 540 and with pseudo-labels (e.g., unlabeled data with pseudo-labels 550). The circular filter model training process 500 utilizes a pseudo-labeling method to label the training data. The pseudo-labeling method uses a minimum amount of labeled data to initiate the training of circular filter machine-learning model 520. The circular filter machine-learning model 520 may be a classifier machine-learning model. In some embodiments, the circular filter machine-learning model 520 is a convolutional neural network (CNN) classifier. Alternatively, the circular filter machine-learning model 520 may be any other type of neural network.

The labeled data 510 may include manually labeled images. The images may be labeled circular or non-circular. The labeled data 510 may include a predetermined number of images (e.g., 10 images, 50 images, 100 images, 1000 images, etc.). The predetermined number of images in the labeled data 510 may be substantially less than the total amount of images used to train the circular filter machine-learning model 520. The labeled data 510 may be provided to the circular filter machine-learning model 520 for training.

The circular filter machine-learning model 520 may be trained for a predetermined number of iterations. A first iteration trains the circular filter machine-learning model 520 using the manually labeled data 510. After the circular filter machine-learning model 520 is trained in the first iteration, the circular filter machine-learning model 520 initiates the label prediction process 530 and predicts one or more labels for unlabeled data 540. The predicted labels are pseudo-labels assigned to the unlabeled data 540. The unlabeled data with pseudo-labels 550 are provided to the validation operation 560. The validation operation 560 ensure accuracy of the generated labels. In some embodiments, the validation operations 560 is a manual validation process (e.g., a user verifies that the appropriate labels were assigned to an image). After the validation operation 560 is performed, the labeled data 510 is updated and/or augmented with the verified images.

The updated and/or augmented labeled data 510 is provided to circular filter machine-learning model 520 for a subsequent iteration of training. The operations of the circular filter model training process 500 are iteratively performed until the circular filter machine-learning model 520 is fully trained. In some embodiments, the circular filter model training process 500 is performed a predetermined number of times (e.g., at 10 times). In this way, the trained circular filter machine-learning model 520 provides an efficient solution for classifying image data.

FIG. 5B shows the circular filter machine-learning model 520 (e.g., the circular filter 472; FIG. 4) assigning one or more labels to the provided images. The circular filter machine-learning model 520 is used to identify image data that is not suitable for a particular request and/or need. For example, the circular filter machine-learning model 520 receives a first image 570, a second image 580, and a third image 590. The circular filter machine-learning model 520 labels the first image 570 as a circular image, the second image 580 as a non-circular image, and the third image 590 as a non-circular image. The circular filter machine-learning model 520 filters out circular images such that the image retrieval process (described above in reference to FIG. 4) is not performed on circular images. In this way, the multimodal image search system 400 quickly and efficiently identifies relevant images without using additional computational resources processing images that are unsuitable.

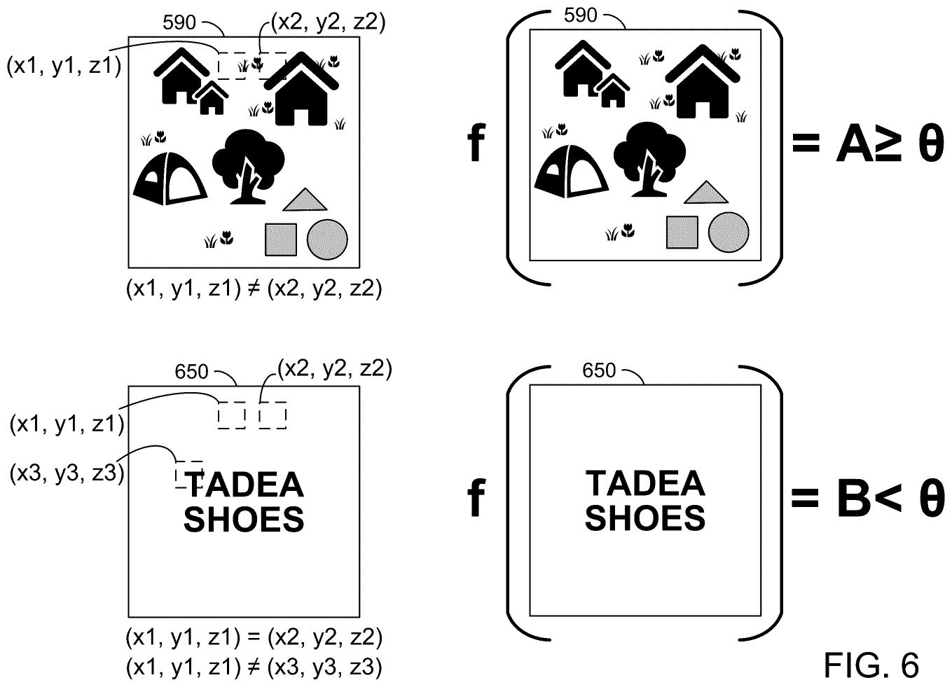

FIG. 6 illustrates a text filter, in accordance with some embodiments. The text filter 474 is a text-heavy filter that identifies images that include a substantial portion of text (e.g., more than 50% of the image is text). The text filter 474 receives an image and represent the image as a 3-dimensional matrix, with each cell of the 3-dimensional matrix corresponding to a pixel's color value. Pixel color values that are the same are classified as non-unique pixel values, and pixel color values that are distinct are classified as unique pixel values. Because it has been discovered that text-heavy images typically contain a limited range of unique pixel values, the text filter 474 compares pixel color values of an image to identify a number of unique pixel values, and filters out images that have a number of unique pixel values below a predetermined threshold. By filtering out images with a number of unique pixel values below the predetermined threshold, the text filter 474 effectively identifies text-heavy images and images with single-color backgrounds (which tend to be less informative). The text filter 474 allows for a more refined focus on visually relevant images, enhancing the overall quality of the filtered image embeddings 480 dataset.

For example, as shown in FIG. 6, the text filter 474 receives the third image 590 and determines pixel color values for the third image 590. The pixel color values of the third image 590 are compared to identify the number of unique pixel values and non-unique pixel values. For example, a first 3-dimensional matrix includes first pixel color values x1, y1, and z1, and a second 3-dimensional matrix includes second pixel color values x2, y2, and z2 distinct from the first pixel color values. In the above example, the pixel color values of the third image 590 are distinct as the background is not uniform and/or there are several distinct objects in the third image 590, which result in distinct pixel color values. The text filter 474 determines a total number of unique pixel values (A) and, in accordance with a determination that the number of unique pixel values (A) is greater than or equal to the predetermined threshold (e.g., θ), determines that the third image 590 is not text heavy.

As also shown in FIG. 6, the text filter 474 receives a fourth image 650 determines pixel color values for the fourth image 650. The pixel color values of the fourth image 650 are compared to identify the number of unique pixel values and non-unique pixel values. For example, a first 3-dimensional matrix includes first pixel color values x1, y1, and z1; a second 3-dimensional matrix includes second pixel color values x2, y2, and z2, and a third 3-dimensional matrix includes third pixel color values x3, y3, and z3. The first and second pixel color values are the same, and the third pixel color values are distinct from the first and second pixel color values. In the above example, the first and second pixel color values of the fourth image 650 are non-unique because they are associated with a single color background, and the third pixel color values of the fourth image 650 are unique as the text would include distinct pixel color values relative to the background. The text filter 474 determines the total number of unique pixel values (B) and, in accordance with a determination that the number of unique pixel values (B) is less than the predetermined threshold (e.g., θ), determines that the fourth image 650 is text heavy.

The text filter 474 filters out text-heavy images such that the image retrieval process (described above in reference to FIG. 4) is not performed on text-heavy images. By excluding text-heavy images from the image retrieval process, the multimodal image search system 400 identifies relevant images efficiently and quickly, as well as provides images suitable for the user's needs.

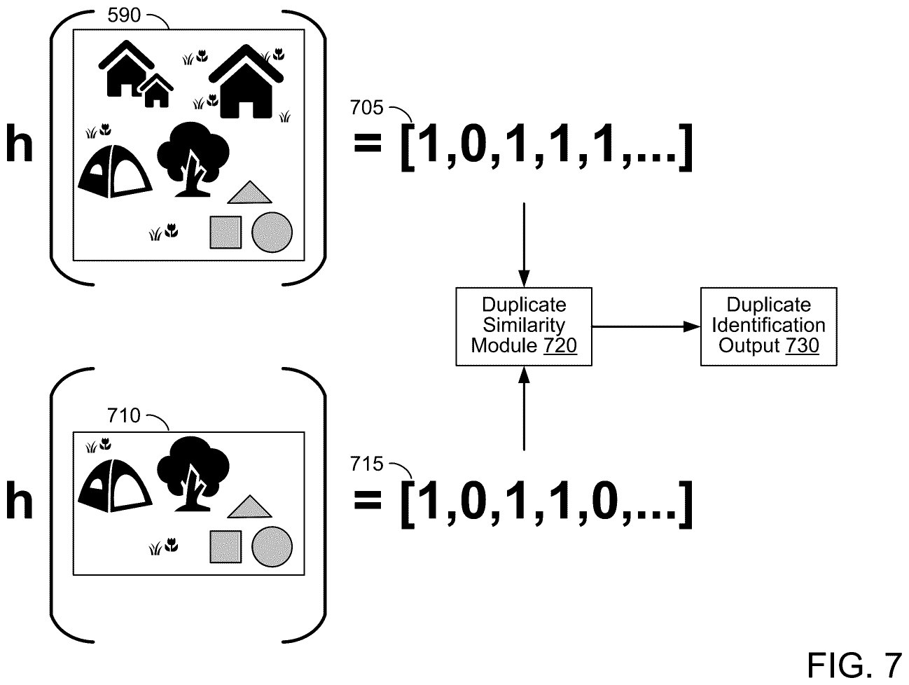

FIG. 7 illustrates a duplication filter, in accordance with some embodiments. The duplication filter 476 identifies images that are substantial similar and/or substantially duplicate. Because the image data 440 (FIG. 4) can include a large number of images and/or other data points, many images can be similar and/or be modified versions of the same image. The duplication filter 476 identifies the similar images and excludes the duplicates from the image retrieval process described above in reference to FIG. 4. Because the image data 440 can include a large number of images and/or other data points, the duplication filter 476 can use K-means clustering techniques on the pre-calculated image embeddings of the images (e.g., the image embeddings 460) to cluster the images into a predetermined number of distinct groups (e.g., 5 groups, 10 group, 15 groups, etc.). By clustering the images into a predetermined number of distinct groups, the duplication filter 476 is able to filter the image data 440 without processing each image, which improves efficiency and latency.

The duplication filter 476 obtains the predetermined number of distinct groups and determines respective hash vectors for respective images in the predetermined number of distinct groups. The duplication filter 476 compares at least two hash vectors of the images (for a particular group) to determine a similarity between the at least two hash vectors. In accordance with a determination that at least two hash vectors are within a predetermined hash threshold, the duplication filter 476 includes an image of the at least two images in the filtered set of the image data (e.g., used to define the filtered image embeddings 480), and excludes other images of the at least two images such that the other images of the at least two images are not used in the image retrieval process described above in reference to FIG. 4.

For example, as shown in FIG. 7, the duplication filter 476 receives the third image 590 and determines a first hash vector 705 for the third image 590. The duplication filter 476 receives the fifth image 710 and determines a second hash vector 715 for the fifth image 710. The fifth image 710 is a cropped or modified version of the third image 590 and, as such, is substantially similar. The duplication filter 476 further compares the first hash vector 705 and the second hash vector 715 using a duplication similarity module 720 to determine whether the at least two hash vectors are within a predetermined hash threshold. For example, as shown in FIG. 7, the first hash vector 705 and the second hash vector 715 are substantially similar with a slight difference in the vectors (e.g., a single cell difference in the portions of the hash vectors shown). In accordance with a determination that the first hash vector 705 and the second hash vector 715 are within the predetermined hash threshold, the duplication filter 476 provides a duplicate identification output 730. The duplicate identification output 730 identifies the duplication, includes the third image 590 or the fifth image 710 in the filtered set of the image data, and excludes the other image from the image retrieval process.

In some embodiments, the duplication filter 476, in accordance with a determination that a duplicate image is present, keeps the original image, the image with the highest resolution, and/or the image that corresponds to the provided request. While the above example compares two hash vectors, in some embodiments, the duplication filter 476 can compare more than two hash vectors at a time.

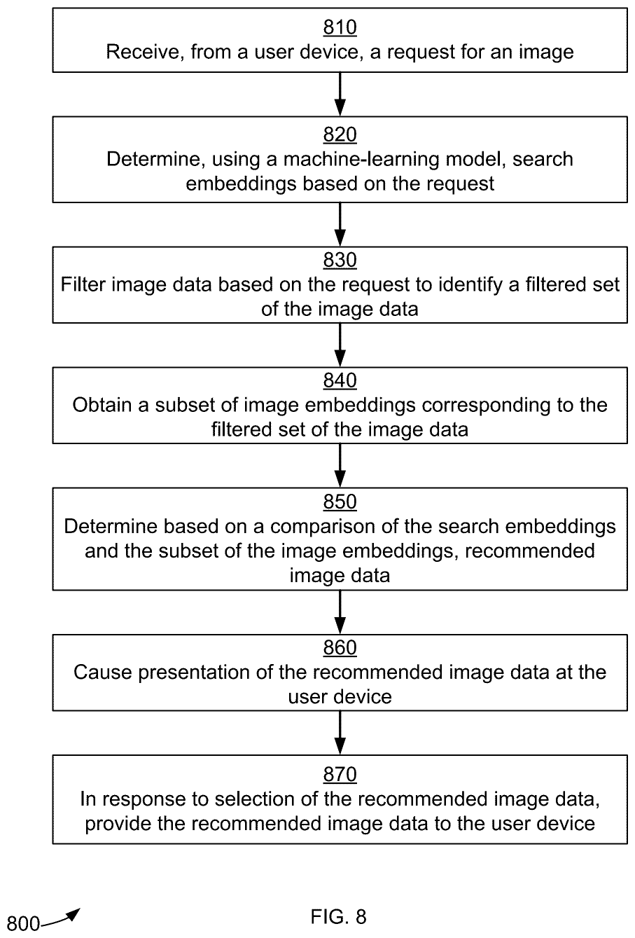

FIG. 8 is a flowchart illustrating a method for retrieving one or more images, in accordance with some embodiments. The method 800 shows various steps of the method. Although embodiments are discussed herein including application of certain steps and/or processes, it will be appreciated that various elements of the method 800 may be performed in various orders and/or performed by additional and/or alternative processes or system elements as those disclosed herein. The steps of the method 800 can be performed by one or more processors (e.g., CPUs, GPUs, etc.) of a system (e.g., a multimodal image retrieval computing device 4 or any other device described above in reference to FIG. 1). At least some of the operations shown in FIG. 8 correspond to instructions stored in a computer memory or computer-readable storage medium (e.g., storage, RAM, and/or memory). Operations of the method 800 can be performed by a single device alone or in conjunction with one or more processors and/or hardware components of another communicatively coupled device and/or instructions stored in memory or computer-readable medium of the other device communicatively coupled to the system. In some embodiments, the various steps of the method 800 described herein are interchangeable and/or optional, and respective steps of the methods 800 are performed by any of the aforementioned devices, systems, or combination of devices and/or systems. For convenience, the method steps will be described below as being performed by particular component or device (e.g., the multimodal image retrieval computing device 4), but should not be construed as limiting the performance of the operation to the particular device in all embodiments.

The method 800 includes receiving (810), from a user device, a request for an image. The method 800 includes determining (820), using a machine-learning model, search embeddings based on the request; filtering (830) image data based on the request to identify a filtered set of the image data; and obtaining (840) a subset of image embeddings corresponding to the filtered set of the image data. For example, as described above in reference to FIG. 4, a user 405 can provide a request via a user device 410. The request is provided to a query module 420 and/or a filter system 470 to determine search query embeddings 430 and to identify the filtered image embeddings 480.

The method 800 further includes determining (850) based on a comparison of the search embeddings and the subset of the image embeddings, recommended image data, and causing (860) presentation of the recommended image data at the user device. For example, as described above in reference to FIG. 4, a similarity module 485 compares the search query embeddings 430 and the filtered image embeddings 480 to identify relevant images. The relevant images are provided to the user device 410 and presented to the user 405 (e.g., via an image retrieval UI 300). The method 800 further includes, in response to selection of the recommended image data, providing (870) the recommended image data to the user device. More specifically, the selected image is provided to the user 405 for use in a particular (marketing) campaign, message, publication, and/or other post.

In some embodiments, filtering the image data based on the request to identify the filtered set of the image data includes determining, using a circular filter, a subset of the image data including circular image data; and excluding the subset of the image data including the circular image data from the filtered set of the image data. In some embodiments, the circular filter is another machine-learning model that determines whether a respective image in the image data is circular, and in accordance with a determination that the respective image is circular, include the respective image in the subset of the image data including the circular image data. Alternatively, the other machine-learning model, in accordance with a determination that the respective image is not circular, includes the respective image in the filtered set of the image data. For example, as described above in reference to FIGS. 5A and 5B, the circular filter 472 is trained to identify and label the image data 440 as circular and/or non-circular, and exclude circular images from the image retrieval process (described above in reference to FIG. 4) and include non-circular images in the filtered image embeddings 480.

In some embodiments, the subset of the image data is a first subset of the image data, and filtering the image data based on the request to identify the filtered set of the image data includes determining, using a text filter, a second subset of the image data including text-heavy image data; and excluding the second subset of the image data including the text-heavy image data from the filtered set of the image data. In some embodiments, using the text filter includes determining a number of unique pixels for a respective image in the image data, and in accordance with a determination that the number of unique pixels satisfies a first predetermined unique pixel threshold, including the respective image in the second subset of the image data including the text-heavy image data. Alternatively, the text filter, in accordance with a determination that the number of unique pixels satisfies a second predetermined unique pixel threshold, includes the respective image in the filtered set of the image data. In some embodiments, the first predetermined unique pixel threshold is less than the second predetermined unique pixel threshold. Alternatively, in some embodiments, the first predetermined unique pixel threshold and the second predetermined unique pixel threshold are the same. In some embodiments, satisfying the first predetermined unique pixel threshold includes a determination that number of unique pixels is equal to or less that the first predetermined unique pixel threshold and satisfying the second predetermined unique pixel threshold includes a determination that number of unique pixels is equal to or greater that the second predetermined unique pixel threshold.

For example, as described above in reference to FIG. 6, the text filter 474 determines pixel color values for an image; identify a total number of unique pixel values in the image; and in accordance with a determination that the number of unique pixel values is below a predetermined unique pixel threshold, label the image as a text-heavy image and exclude the text-heavy image from the image retrieval process (described above in reference to FIG. 4). Alternatively, the text filter 474, in accordance with a determination that the number of unique pixel values is greater than or equal to the predetermined unique pixel threshold, includes the image in the filtered image embeddings 480.

In some embodiments, the subset of the image data is a first subset of the image data, and filtering the image data based on the request to identify the filtered set of the image data includes determining, using a duplication filter, a third subset of the image data including duplicate image data; and excluding the third subset of the image data including the duplicate image data from the filtered set of the image data. In some embodiments, using the duplication filter includes determining a respective hash value (or hash vectors) for each image in the image data; and in accordance with a determination that at least two images have hash values (or hash vectors) within a first predetermined hash threshold, including an image of the at least two images in the filtered set of the image data, and including other images of the at least two images in the third subset of the image data including the duplicate image data. Alternatively, the duplication filter, in accordance with a determination that at least two images have hash values (or hash vectors) within a second predetermined hash threshold, includes the at least two images in the filtered set of the image data. As described above, the duplication filter can determine respective hash values (or hash vectors) for images of a predetermined number of distinct groups in order to reduce the number of hash value determinations. In some embodiments, the first predetermined hash threshold is greater than the second predetermined hash threshold. Alternatively, in some embodiments, the first predetermined hash threshold and the second predetermined hash threshold are the same. In some embodiments, a determination the at least two images have hash values (or hash vectors) within the first predetermined hash threshold includes a determination that the hash values (or hash vectors) have a similarity score that is equal to or greater than the first predetermined hash threshold, and a determination the at least two images have hash values (or hash vectors) within the second predetermined hash threshold includes a determination that the hash values (or hash vectors) have a similarity score that is equal to or less than the second predetermined hash threshold.

For example, as described above in reference to FIG. 7, the duplication filter 476 determines hash vectors for at least two images; compare the hash vectors of the at least two images; and in accordance with a determination that the hash vectors are within a predetermined hash threshold, include at least one image of the at least two images in the filtered image embeddings 480 and exclude the other images of the at least two images from the image retrieval process (described above in reference to FIG. 4). Alternatively, the duplication filter 476, in accordance with a determination that the hash vectors are not within the predetermined hash threshold, include at least two images in the filtered image embeddings 480 (e.g., in other words, the images are not duplicates and are included in the image retrieval process).

In some embodiments, the image embeddings are indexed with the image data. As described above in reference to FIG. 4, by (pre) indexing the image embeddings 460 with the image data 440, it is possible to retrieve respective images efficiently and quickly, which allows for improved scalability of the multimodal image search system 400. In some embodiments, the request for the image is one or more of a text-based request (e.g., a text query and/or a text search), an image-based request (e.g., an image search), and/or a campaign request (a request provided by a campaign generation module or system that includes a text-based request, an image-based request, and/or computer readable instructions for performing a search).

In some embodiments, the request includes a filter attribute defining one or more filters for filtering the image data. For example, as described above in refence to FIG. 4, selection of one or more filters be provided via a request and/or UI elements in a UI (e.g., an image retrieval UI 300).

In some embodiments, the machine-learning model is trained using incremental task scaling fine-tuning. Incremental task scaling fine-tuning includes providing a first set of tasks to train the machine-learning model, and providing a second set of tasks to train the machine-learning model after completion of the first set of tasks. The first set of tasks has a first complexity, and the second set of tasks has a second complexity greater than the first complexity. In some embodiments, the first set of tasks includes a first set of data, the first set of data including first training image data and training text; and the second set of tasks includes a second set of data, the second set of data including second training image data and training categories. Additional information on the incremental task scaling fine-tuning is provided above in reference to FIG. 4.

In accordance with some embodiments, a non-transitory computer readable storage medium may include instructions that, when executed by a computing device, cause the computer device to perform steps corresponding to method 800.

In accordance with some embodiments, a system including a multimodal image retrieval computing device, a user device, and/or other device described above in FIG. 1 may perform the steps of method 800.

In accordance with some embodiments, a computing device (e.g., a multimodal image retrieval computing device, a user device, and/or other device describe above in FIG. 1) may perform the steps of method 800.

Although the subject matter has been described in terms of example embodiments, it is not limited thereto. Rather, the appended claims should be construed broadly, to include other variants and embodiments, which may be made by those skilled in the art.

What is claimed is:

1. A system, comprising:
a database including image data and image embeddings;
a processor; and
a non-transitory memory storing instructions, that when executed, cause the processor to:
receive, from a user device, a request for an image;
determine, using a machine-learning model, search embeddings based on the request;
filter the image data based on the request to identify a filtered set of the image data;
obtain a subset of the image embeddings corresponding to the filtered set of the image data;
determine, based on a comparison of the search embeddings and the subset of the image embeddings, recommended image data;
cause a presentation of the recommended image data at the user device; and
in response to a selection of a recommended image from the recommended image data, provide the recommended image to the user device.

2. The system of claim 1, wherein the request comprises at least one of: a text portion, an image portion, or a campaign related portion.

3. The system of claim 2, wherein the instructions, when executed, cause the processor to determine the search embeddings based at least by:
generating, using a text query encoder of the machine-learning model, at least one text query embedding based on the text portion;
generating, using an image query encoder of the machine-learning model, at least one image query embedding based on the image portion; and
determining the search embeddings based on the at least one text query embedding and the at least one image query embedding.

4. The system of claim 1, wherein the instructions, when executed, further cause the processor to train the machine-learning model based at least by:
training the machine-learning model using a first set of tasks having a first complexity; and
re-training the machine-learning model using a second set of tasks having a second complexity greater than the first complexity, after completion of the first set of tasks.

5. The system of claim 4, wherein:
the first set of tasks includes training data related to one or more image-text pairs each of which is formed by an image and a text corresponding to the image;
the machine-learning model is trained using the first set of tasks based on a cross entropy loss of image embeddings and text embeddings;
the second set of tasks includes training data related to one or more image-category pairs each of which is formed by an image of a corresponding product and a category of the corresponding product; and
the machine-learning model is re-trained using the second set of tasks based on a cross entropy loss of image embeddings and category embeddings.

6. The system of claim 1, wherein the instructions, when executed, cause the processor to filter the image data based by at least one of:
identifying and excluding circular images from the filtered set of the image data using a circular filter based on the request, wherein each of the circular images has a circular shape;
identifying and excluding text-heavy images from the filtered set of the image data using a text filter based on the request, wherein each text-heavy image of the text-heavy images has a text portion occupying more than half of the text-heavy image; or
identifying and excluding duplicated images from the filtered set of the image data using a duplication filter based on the request, wherein each of the duplicated images has a hash vector based similarity score higher than a predetermined threshold with respect to an existing image in the filtered set of the image data.

7. The system of claim 1, wherein the instructions, when executed, cause the processor to determine the recommended image data based at least by:
comparing the search embeddings with the subset of the image embeddings to compute cosine similarity distances;
generate ranking scores for the subset of the image embeddings based on the cosine similarity distances;
selecting one or more image embeddings having highest ranking scores among the subset of the image embeddings, and
determining the recommended image data corresponding to the one or more image embeddings.

8. A computer-implemented method, comprising:
receiving, from a user device, a request for an image;
determining, using a machine-learning model, search embeddings based on the request;
filtering image data based on the request to identify a filtered set of the image data;
obtaining a subset of image embeddings corresponding to the filtered set of the image data;
determining, based on a comparison of the search embeddings and the subset of the image embeddings, recommended image data;
causing a presentation of the recommended image data at the user device; and
in response to a selection of a recommended image from the recommended image data, providing the recommended image to the user device.

9. The computer-implemented method of claim 8, wherein the request comprises at least one of: a text portion, an image portion, or a campaign related portion.

10. The computer-implemented method of claim 9, wherein determining the search embeddings comprises:
generating, using a text query encoder of the machine-learning model, at least one text query embedding based on the text portion;
generating, using an image query encoder of the machine-learning model, at least one image query embedding based on the image portion; and
determining the search embeddings based on the at least one text query embedding and the at least one image query embedding.

11. The computer-implemented method of claim 8, further comprising training the machine-learning model based at least by:
training the machine-learning model using a first set of tasks having a first complexity; and
re-training the machine-learning model using a second set of tasks having a second complexity greater than the first complexity, after completion of the first set of tasks.

12. The computer-implemented method of claim 11, wherein:
the first set of tasks includes training data related to one or more image-text pairs each of which is formed by an image and a text corresponding to the image;
the machine-learning model is trained using the first set of tasks based on a cross entropy loss of image embeddings and text embeddings;
the second set of tasks includes training data related to one or more image-category pairs each of which is formed by an image of a corresponding product and a category of the corresponding product; and
the machine-learning model is re-trained using the second set of tasks based on a cross entropy loss of image embeddings and category embeddings.

13. The computer-implemented method of claim 8, wherein filtering the image data comprises at least one of:
identifying and excluding circular images from the filtered set of the image data using a circular filter based on the request, wherein each of the circular images has a circular shape;
identifying and excluding text-heavy images from the filtered set of the image data using a text filter based on the request, wherein each text-heavy image of the text-heavy images has a text portion occupying more than half of the text-heavy image; or
identifying and excluding duplicated images from the filtered set of the image data using a duplication filter based on the request, wherein each of the duplicated images has a hash vector based similarity score higher than a predetermined threshold with respect to an existing image in the filtered set of the image data.

14. The computer-implemented method of claim 8, wherein determining the recommended image data comprises:
comparing the search embeddings with the subset of the image embeddings to compute cosine similarity distances;
generate ranking scores for the subset of the image embeddings based on the cosine similarity distances;
selecting one or more image embeddings having highest ranking scores among the subset of the image embeddings, and
determining the recommended image data corresponding to the one or more image embeddings.

15. A non-transitory computer readable medium having instructions stored thereon, wherein the instructions, when executed by at least one processor, cause at least one device to perform operations comprising:
receiving, from a user device, a request for an image;
determining, using a machine-learning model, search embeddings based on the request;
filtering image data based on the request to identify a filtered set of the image data;
obtaining a subset of image embeddings corresponding to the filtered set of the image data;
determining, based on a comparison of the search embeddings and the subset of the image embeddings, recommended image data;
causing a presentation of the recommended image data at the user device; and
in response to a selection of a recommended image from the recommended image data, providing the recommended image to the user device.

16. The non-transitory computer readable medium of claim 15, wherein:
the request comprises at least one of: a text portion, an image portion, or a campaign related portion; and
determining the search embeddings comprises:
generating, using a text query encoder of the machine-learning model, at least one text query embedding based on the text portion,
generating, using an image query encoder of the machine-learning model, at least one image query embedding based on the image portion, and
determining the search embeddings based on the at least one text query embedding and the at least one image query embedding.

17. The non-transitory computer readable medium of claim 15, wherein the operations further comprise training the machine-learning model based at least by:
training the machine-learning model using a first set of tasks having a first complexity; and
re-training the machine-learning model using a second set of tasks having a second complexity greater than the first complexity, after completion of the first set of tasks.

18. The non-transitory computer readable medium of claim 17, wherein:
the first set of tasks includes training data related to one or more image-text pairs each of which is formed by an image and a text corresponding to the image;
the machine-learning model is trained using the first set of tasks based on a cross entropy loss of image embeddings and text embeddings;
the second set of tasks includes training data related to one or more image-category pairs each of which is formed by an image of a corresponding product and a category of the corresponding product; and
the machine-learning model is re-trained using the second set of tasks based on a cross entropy loss of image embeddings and category embeddings.

19. The non-transitory computer readable medium of claim 15, wherein filtering the image data comprises at least one of:
identifying and excluding circular images from the filtered set of the image data using a circular filter based on the request, wherein each of the circular images has a circular shape;
identifying and excluding text-heavy images from the filtered set of the image data using a text filter based on the request, wherein each text-heavy image of the text-heavy images has a text portion occupying more than half of the text-heavy image; or
identifying and excluding duplicated images from the filtered set of the image data using a duplication filter based on the request, wherein each of the duplicated images has a hash vector based similarity score higher than a predetermined threshold with respect to an existing image in the filtered set of the image data.

20. The non-transitory computer readable medium of claim 15, wherein determining the recommended image data comprises:
comparing the search embeddings with the subset of the image embeddings to compute cosine similarity distances;
generate ranking scores for the subset of the image embeddings based on the cosine similarity distances;
selecting one or more image embeddings having highest ranking scores among the subset of the image embeddings, and
determining the recommended image data corresponding to the one or more image embeddings.
